(19) United States
(12) Patent Application Publication
(10) Pub. No.: US 2018/0280246 A1
(43) Pub. Date: Oct. 4, 2018

(54) SMART CONTAINER INSERT

(71) Applicant: Secure Medication Systems, LLC, Fort Collins, CO (US)

(72) Inventors: Milton Cohen, Greenwood Village, CO (US); Sean SereII, Fort Collins, CO (US)

(73) Assignee: Secure Medication Systems, LLC, Fort Collins, CO (US)

(21) Appl. No.: 15/943,132

(22) Filed: Apr. 2, 2018

Related U.S. Application Data
(60) Provisional application No. 62/480,635, filed on Apr. 3, 2017.

(51) Int. Cl. A61J 7/04; G08B 13/08

(52) U.S. Cl. CPC A61J 7/0436; G08B 13/08; A61J 2200/72; A61J 2200/30; A61J 7/0481

(57) ABSTRACT

Disclosed is a messaging system that can be used with either a locked or unlocked container to indicate an elapsed time, such as an elapsed time for taking medication, unauthorized movement, or opening of the container. A capsule placed in the container communicates to an application that may generate alerts for vial openings, failure to open vial when medication due, pilfering or unauthorized movement. A battery in the capsule can be recharged through contacts or induction charging. Various types of sensors can be used in the capsule, including pressure sensors, light sensors, an accelerometer, a capacitive sensor, and a conductive sensor.

### CROSS REFERENCE TO RELATED APPLICATIONS

The present application claims the benefit of U.S. provisional application 62/480,635, filed Apr. 3, 2017. The entire disclosures of the above references are incorporated herein by reference in entirety for all purposes.

### FIELD OF THE INVENTION

The field relates generally to containment mechanism and processes for sending signals related to containment mechanisms.

### BACKGROUND OF THE INVENTION

Some individuals are required to take medications on a daily basis, or even multiple times during a single 24-hour period. Periodic medications are important in certain circumstances to prevent serious medical conditions from creating problems. For example, many individuals are required to take blood pressure medicine to control their blood pressure. Failure to take the blood pressure medicine on a daily basis may result in the individual having a stroke, heart attack, or other serious problems created by high blood pressure. Moreover, there is a need for notification when a container containing such medications, and other potentially dangerous or hazardous substances, is moved, opened or tampered with in an undesirable fashion.

### SUMMARY

An embodiment of the present invention may therefore comprise a system generating message signals regarding opening events of a container comprising: a cap that is disposed on the container; a capsule disposed in the container, the capsule comprising: at least one sensor that generates a first sensor signal when the cap is removed from the container; a compute engine that generates a first message signal from the first sensor signal indicating that an event has occurred; a communication system that generates a transmission signal from the first message signal; an antenna that receives the transmission signal and transmits an signal, such as an EMR signal, to a network that indicates the event has occurred.

An embodiment of the present invention may further comprise a method of generating messages regarding the status of a container comprising: placing a capsule in the container, the capsule having a compute engine and sensors; detecting sensor signals from the sensors with the compute engine that may indicate an occurrence of at least one event relating to the container; generating a first message signal, with the compute engine, from the sensor signals; transmitting the first message signal to at least one user computer; receiving the first message at the user computer and generating a second message signal based upon the first message signal.

An embodiment of the present invention may further comprise a system for protecting and controlling access to contents of a container comprising: a locking cap that is placable on the container that locks the container to prevent access to the contents of the container; a capsule disposed in the container, the capsule comprising: at least one sensor that generates a first sensor signal when the locking cap is removed from the container; a clock that generates a clock signal; a counter that accumulates the clock signal and generates an accumulated clock signal; storage that stores a predetermined count signal representative of an elapsed time period; a compute engine that compares the accumulated clock signal with the predetermined count signal and generates a first message signal when the accumulated clock signal matches the predetermined count signal indicating the elapsed time has expired, and generates a second message signal whenever the first sensor signal is received prior to expiration of the elapsed time. As used herein, the term “placable” shall be defined as “able to be placed.” As used herein, the term “compute engine” is defined as “a processor, microprocessor, CPU, programmable gate array, or a substantial equivalent as determined by one skilled in the art.”

An embodiment of the present invention may further comprise a method of generating messages regarding the status of a locked container comprising: placing a capsule in the container, the capsule having a compute engine; detecting sensor signals from the sensors with the compute engine that may indicate an opening event of the locked container; determining, with the compute engine, if the sensor signals indicate an opening event of the locked container; determining whether the opening event occurred during an opening window; transmitting a message of the opening event to a user application if the opening event occurred outside of an opening window indicating an unauthorized opening of the locked container.

An embodiment of the present invention may further comprise a self-contained electronic device for insertion in a container that detects opening events of the container comprising: at least one sensor that detects the opening events and generates opening event signals; a compute engine that receives the opening event signals and generates opening event messages; a battery that supplies power to the self-contained electronic device; an antenna that transmits the opening event messages.

### BRIEF DESCRIPTION OF THE DRAWINGS

FIG. 1A is a schematic representation of one embodiment of a capsule.

FIG. 1B is a schematic representation of an embodiment of a capsule in a non-locking container.

FIG. 1C is a schematic representation of an embodiment of a capsule in a locking container.

FIG. 2 is a schematic block diagram of an embodiment of the components of a capsule.

FIG. 3 is a schematic block diagram of an embodiment of a sensor.

FIG. 4 is a flow chart of one embodiment of the operation of a compute engine, such as, for example only, a microprocessor.

FIG. 5 is a flow chart illustrating one embodiment of a process for generating a vial opening signal with multiple sensors.

FIG. 6 is a schematic flow diagram of an embodiment of a process performed by a compute engine, such as, for example only, a compute engine, such as, for example only, a microprocessor, receiving dispending data from an application.

FIG. 7 is a flow chart of an embodiment of functions of the smart phone application.

FIG. 8 is a schematic block diagram of another embodiment of a capsule

FIG. 9 is an illustration of an embodiment of a network communication system.

FIG. 10 is a schematic diagram of an embodiment of a direct local communication link between a capsule and a smart phone, or other computer device.

FIG. 11 is a schematic block diagram illustrating one embodiment of one set of operations of a compute engine, such as, for example only, a microprocessor.

FIG. 12 is a schematic flow diagram of an embodiment of the operation of an application that may be used with the capsule illustrated in FIG. 8.

FIG. 13 is a schematic flow diagram of an embodiment of the process of sending messages to take medication.

### DETAILED DESCRIPTION

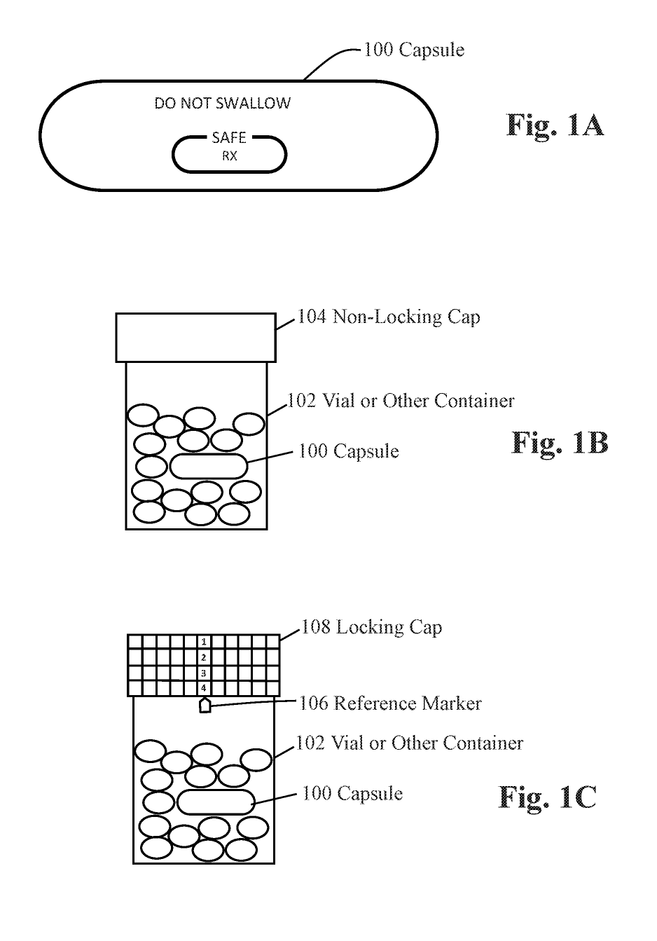

FIG. 1A is a schematic illustration of a capsule 100 that can be placed in or on a container, such as, but not limited to, a medicine vial, which may hold prescription drugs or any other type of container. The capsule 100 may be a silicon encased device with pharmaceutical grade silicon, or any other material, including, but not limited to, plastic. The capsule 100 may vary in size, but may be as small as ¾ of an inch long and ⅜ of an inch in diameter. The capsule 100 may have a cylindrical shape, or any desired shape. The capsule 100, illustrated in FIG. 1, is one embodiment of a capsule. However, the capsule 100 may take various shapes and may be various sizes to accommodate the various components of the capsule.

The capsule 100 of FIG. 1 is placed inside of a vial, such as a medicine bottle, or other container, such container 102 (FIG. 1B and FIG. 1C), and communicates through a communication system to an application that may be run on a server or smart phone, as described in more detail below. The capsule 100 is self-contained and is portable, so that it can be placed in various locations and provide information regarding an opening event, a movement event, or other events, as described in more detail below. The capsule 100 can be used to detect opening events, movement events, or other events, for various items, including, but not limited to, bottles, jars, safes, various locking apparatus, shipping containers, or any device which a user may desire to be notified of an opening event, or movement event, etc., of that item or device. In that regard, U.S. Pat. No. 8,875,915, issued Nov. 4, 2014, to Sean Serell. U.S. Design Pat. No. D741,713, issued Oct. 27, 2015, to Sean Serell, U.S. Design Pat. No. D742,116, issued Nov. 3, 2015, to Sean Serell, U.S. Design Pat. No. D746,058, issued Dec. 29, 2015, to Sean Serell, U.S. Design Pat. No. D747,606, issued Jan. 19, 2016, to Sean Serell, U.S. Design Pat. No. D747,607, issued Jan. 19, 2016, to Sean Serell, and U.S. patent application Ser. No. 14/679,646, filed Apr. 6, 2015, by Sean Serell, disclose containers for use with the present invention, which are specifically incorporated herein by reference for all that they disclose and teach.

The capsule 100, of FIG. 1, can be used in conjunction with locking caps, such as the locking caps disclosed in U.S. Pat. No. 8,875,915, issued Nov. 4, 2014, to Sean Serell, entitled “Container Having a Programmable Combination Locking Cap,” which is specifically incorporated herein by reference for all that it discloses and teaches. A locking cap for a vial or other container is illustrated in FIG. 1C and described in more detail below. The use of a locking cap, together with capsule 100, provides the security for determining if prescription medicines, or other valuables, such as, but not limited to, jewelry, money, liquor, non-prescription drugs, ammunition, guns, etc. have been accessed.

FIG. 1B is a schematic side transparency view of a vial or container 102 that has a non-locking cap 104. The capsule 100 can be placed in or outside of the vial or container 102, together with medications or other items, such as, but not limited to, money, jewelry, non-prescription drugs, liquor, ammunition, guns, or other valuables. The capsule 100 can indicate whether the non-locking cap 104 has been opened and if the vial or other container 102 has been moved.

Figure IC is a schematic transparency view of the vial or other container 102 with a locking cap 108. As shown in Figure IC, the capsule 100 is placed in the vial or other container 102 with other items, such as prescription drugs, non-prescription drugs, valuables, jewelry, money, liquor, ammunition, or other items that the user desires to protect. The capsule may also be attached to the outside of the container, such as, for example, a shipping container. The locking cap 108 can be any desired locking cap. An embodiment of a locking cap that can be used with a vial or other container 102 is disclosed in the above-referenced U.S. Pat. No. 8,875,915 that is incorporated herein by reference. The locking cap 108 as a series of dials that can be adjusted to place the combination on the cap in alignment with the referenced marker 106. The locking cap can then be removed. The capsule 100 can generate various messages and information regarding an opening event, a movement event, or a pilfering event.

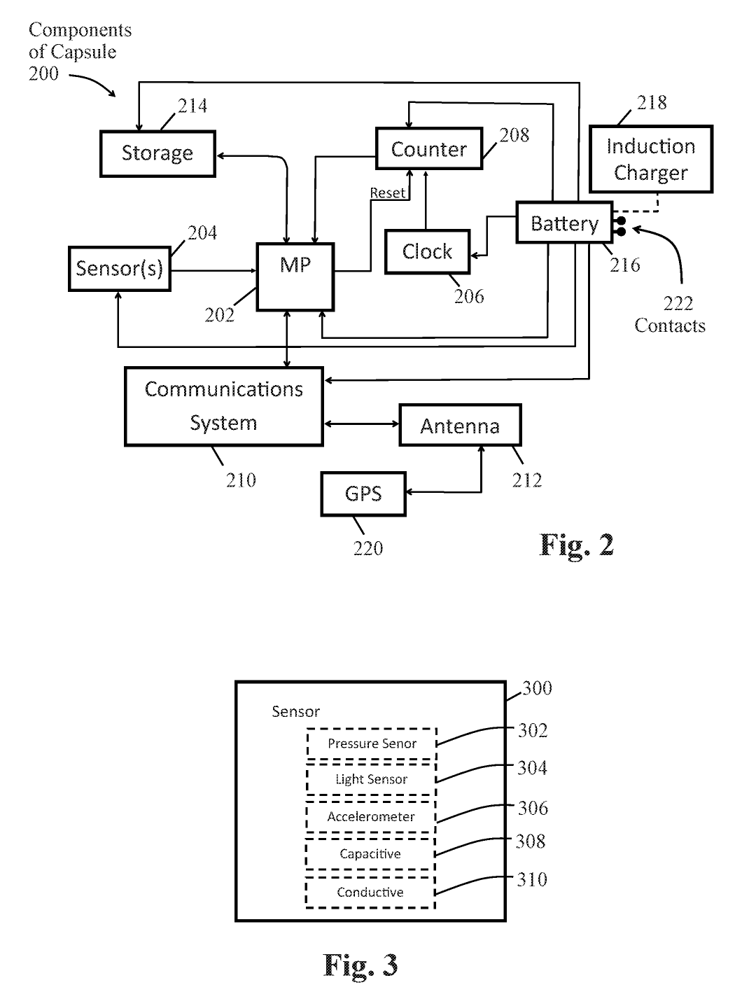

FIG. 2 is a schematic block diagram of an embodiment of the components 200 that may be included in the capsule 100. As illustrated in FIG. 2, a compute engine, such as, for example only, a microprocessor 202 is utilized, which provides for the various processing that is done in the capsule 100. Sensors 204 may include various types of sensors, or only a single sensor. As shown in FIG. 3, sensors 300 may include a pressure sensor 302, a light sensor 304, an accelerometer 306, a capacitive sensor 308, or a conductive sensor 310. Pressure sensor 302 may detect a change in barometric pressure that results from opening or closing a container, and especially a pneumatic sealing cap. Light sensor 304 will detect a change in the light intensity if the cap is removed or replaced on a container that contains the capsule 100, or an opening of any type of container. An accelerometer 306 may detect motion of the container in which the capsule 100 is contained. A capacitive sensor 308 may detect a difference in capacitance between metal layers or wires placed in the container and the cap. A conductive sensor 310 may detect a completed circuit or an open circuit that may occur when a cap is placed on or removed from a container.

The compute engine, such as, for example only, a microprocessor 202, of FIG. 2, is programmed to determine one or more events, such as an opening event, a motion event, a breaking event, a pilfering, or other events, based upon the inputs from sensors 204. For example, the compute engine, such as, for example only, a microprocessor 202 may determine if an opening event has occurred when the light sensor 304 and the pressure sensor 302 have been activated. Similarly, an opening event may be determined by the compute engine, such as, for example only, a compute engine, such as, for example only, a microprocessor 202 from a single sensor, such as when an open circuit is detected by the conductive sensor 310 and/or activation of the capacitive sensor 308. Of course, it may be desirable to only have a single sensor in the capsule 100 to determine certain events, such as an opening event. Further, a motion event may be detected by the accelerometer 306. A user may wish to know if his or her prescription drugs have been moved or tampered with by someone. As another example, a user may have a locking container for marijuana or other non-prescription drugs, ammunition, guns, money, jewelry, liquor, or valuables, and may wish to know when the container has been moved or tampered with by a third person. The accelerometer 306, as well as the light sensor 304, may provide an indication of movement or tampering of both locked and unlocked containers. The compute engine can detect inputs from these sensors that can be used to signal a user of movement or tampering, as disclosed in more detail below.

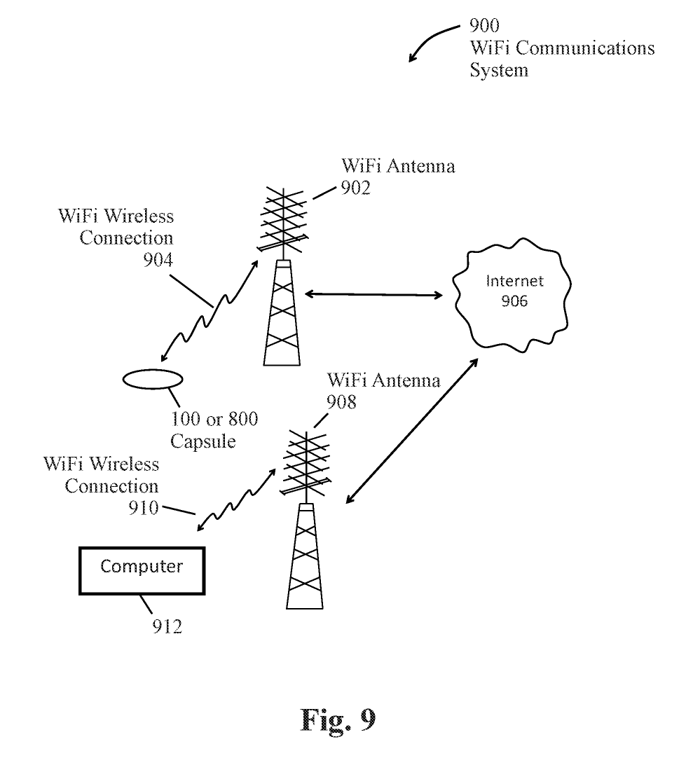

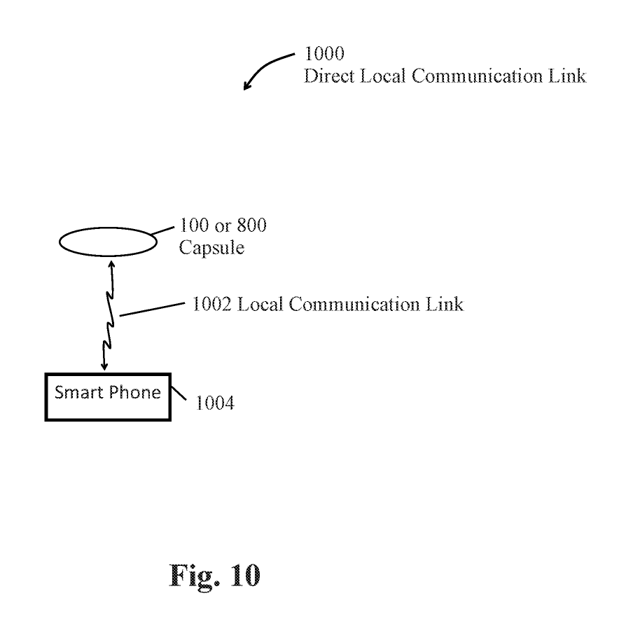

In one embodiment, a clock 206 generates a clock signal, which is applied to counter 208, as illustrated in FIG. 2. The compute engine can generate a reset signal that resets the counter to zero upon the occurrence of certain events, such as an opening event. The counter then generates an accumulated count signal that is applied to the compute engine, such as, for example only, a microprocessor 202, since the counter 208 accumulates the clock pulses and provides the accumulated count to the compute engine, such as, for example only, a microprocessor 202. As described in more detail below, the compute engine, such as, for example only, a microprocessor 202 may compare the accumulated count signal with a predetermined count to indicate an elapsed time period. For example, and as disclosed in more detail below, a predetermined accumulated count signal may be representative of the elapsed time between taking a prescription medication. When the compute engine determines that the accumulated count on the counter 208 matches or exceeds the predetermined count, the compute engine can then generate a signal that is transmitted to the communication system 210 to generate a message that is transmitted over antenna 212 to an application on a server or smart phone to indicate to a user that his or her medication is due. The communication system 210 encodes a signal that uniquely identifies the capsule 100. Marking on the capsule 100 can also uniquely identify the capsule 100. The predetermined count can be stored in storage 214 and accessed by the compute engine, such as, for example only, a microprocessor 202 for comparison with the accumulated count. Other information can also be stored on storage 214, which is accessed by the compute engine, such as, for example only, a microprocessor 202 for generating comparison data and for other purposes. Battery 216 is used to power each of the components 200 of the capsule 100. The battery may be charged and recharged through an induction charger 218. The communication system may be a blue tooth communication system or other system for connecting to a network or directly to an application on a smart phone, as disclosed in more detail below with respect to FIGS. 9 and 10. The antenna 212 can be a simple plate antenna that is either disposed inside the capsule 100 or on the outer surface. The use of the induction charger may constitute an optional manner of charging the battery 216. Other options include providing contacts 222 on the outside of the capsule 100 that allow the battery to be recharged. The capsule TOO can be deposited in a charging station (not shown) that can provide the induction charging or direct contact charging. Again, the capsule 100 can take any desired shape and can provide a shape that allows for contacts to be easily accessed for charging.

FIG. 2 also illustrates an optional GPS system 220 that may be activated by the compute engine, such as, for example only, a microprocessor 202 upon receipt of a signal from the communication system 210 to provide a GPS location signal that is transmitted via antenna 212. In this manner, the compute engine, such as, for example only, a microprocessor 202 can activate the GPS system 220 on command, so that the capsule 100 can be located. This may be advantageous if prescription medicines, non-prescription medicines, liquor, ammunition, guns, valuables such as money or jewelry, are disposed in a locked or unlocked container and the locked or unlocked container is removed to a remote location. In one embodiment, the GPS system 220 may be automatically activated if the accelerometer 306 transmits signals for longer than a predetermined period, as determined by the accumulated count of counter 208.

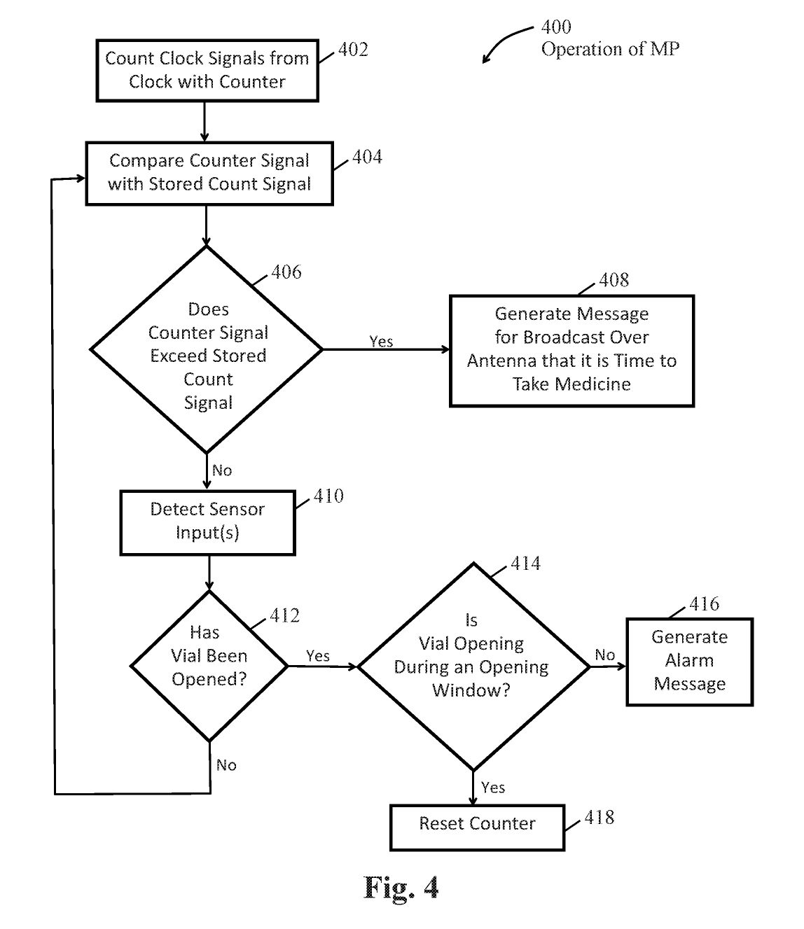

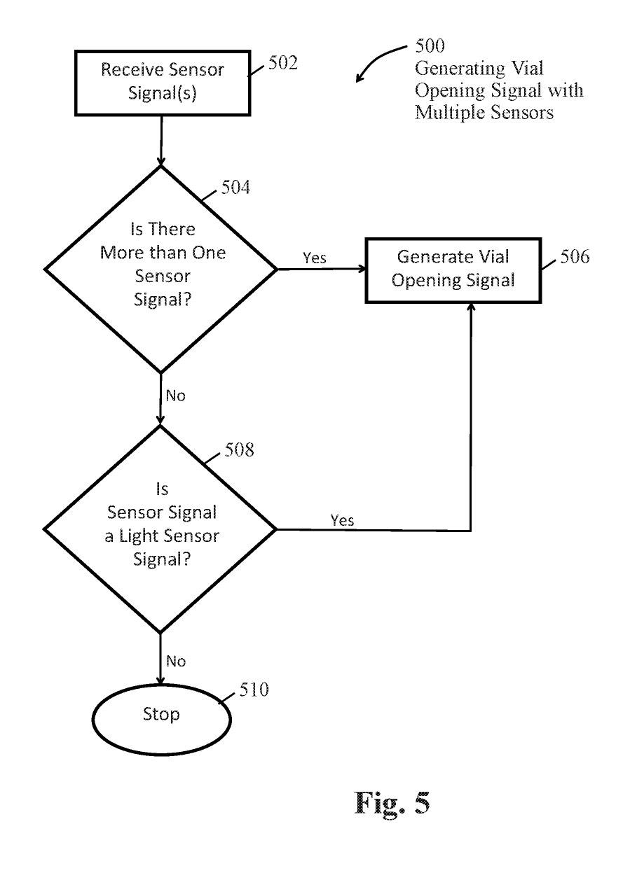

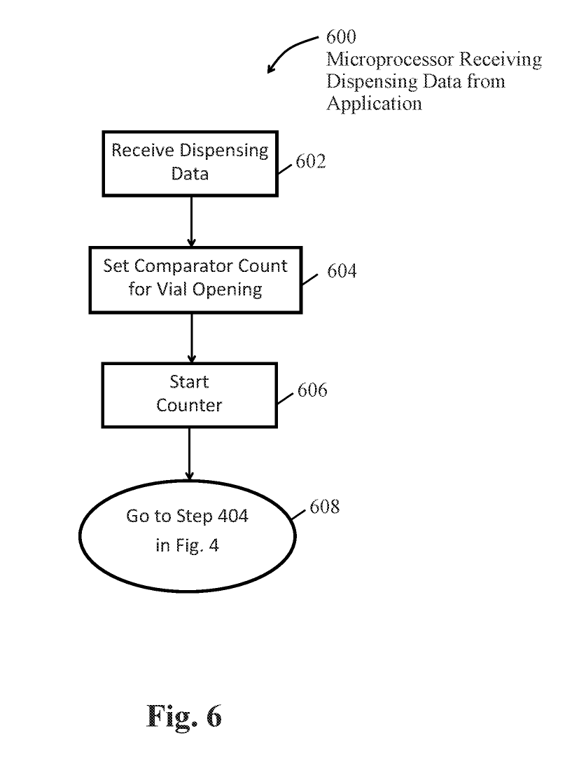

FIG. 4 is a flow chart illustrating one embodiment of the operation 400 of the compute engine, such as, for example only, a microprocessor 202 of FIG. 2. As illustrated in FIG. 4, the counter 208 counts the clock signals from the clock 206. The accumulated count signal from the counter 208 is then compared with a stored count signal that is stored in storage device 214. The compute engine, such as, for example only, a microprocessor 202 then determines whether the counter signal exceeds the stored count signal at step 406. If the counter signal exceeds the stored count signal, a message is generated by the compute engine for broadcast by the communication system 210 over antenna 212 that is transmitted to a network or directly to a smart phone that it is time to take the medicine, or that the locked container has been moved. If the counter signal does not match or exceed the stored count signal, at step 406, the process proceeds to step 410. At step 410, the compute engine detects sensor input(s) at step 410. As set forth above, various combinations of sensor signals, or a single sensor signal, may indicate whether or not the vial, or other container in which the capsule 100 is deposited, has been opened. If the container has not been opened, the process returns to step 404, where the counter signal is compared with the stored count signal. If the sensor signals, as determined by the compute engine, such as, for example only, a microprocessor 202, indicate that the sensor has been opened, or breached in some manner, the process proceeds to decision step 414. At decision step 414, it is determined whether the opening of the vial or container is during an opening window. An opening window is a time period during which a user should be opening the container to take medication. A separate counter can be used to track the opening window. If the container or vial is opened during an opening window, the counter is reset at step 418. If the vial or container is opened outside of an opening window, an alarm message is generated by step 416, which is transmitted to the network or application on the smart phone via the communication system 210 and antenna 212. For example, if it is determined that a pain medication is being accessed too frequently, a message can be sent to a network indicating a possible abuse of the pain medication.

FIG. 5 is a schematic flow diagram of an embodiment of a process 500 of determining whether the vial or container has been opened, such as the decision made at step 412 of FIG. 4. As illustrated in FIG. 5, the compute engine receives the sensor signals from sensors 204 at step 502. At step 504, it is determined whether there is more than one sensor signal. If there is more than one sensor signal, the compute engine can use a decision table to determine if there has been an opening event. For example, the conduction sensor may detect an open circuit being created, which is a clear indication of an opening event. If a conduction sensor is not one of the activated sensors, a combination of a light sensor and a pressure sensor may be used to determine an opening event. In other words, a single sensor signal, as well as a combination of sensor signals, may be used to make a determination of an opening event to generate an opening signal at step 506. Returning to decision step 504, if it is determined that there is only one sensor signal and there are multiple sensors in the capsule 100, the process proceeds to decision step 508. At decision step 508, it is determined whether the single sensor signal indicates a vial opening. For example, activation of an accelerometer signal does not necessarily indicate that the vial has been opened. However, a signal from the conduction sensor of an open circuit would clearly indicate an opening event. In that case, the process would proceed to step 506 and generate a vial opening signal. If the single sensor signal does not indicate an opening event, the process proceeds to step 510, which stops the process.

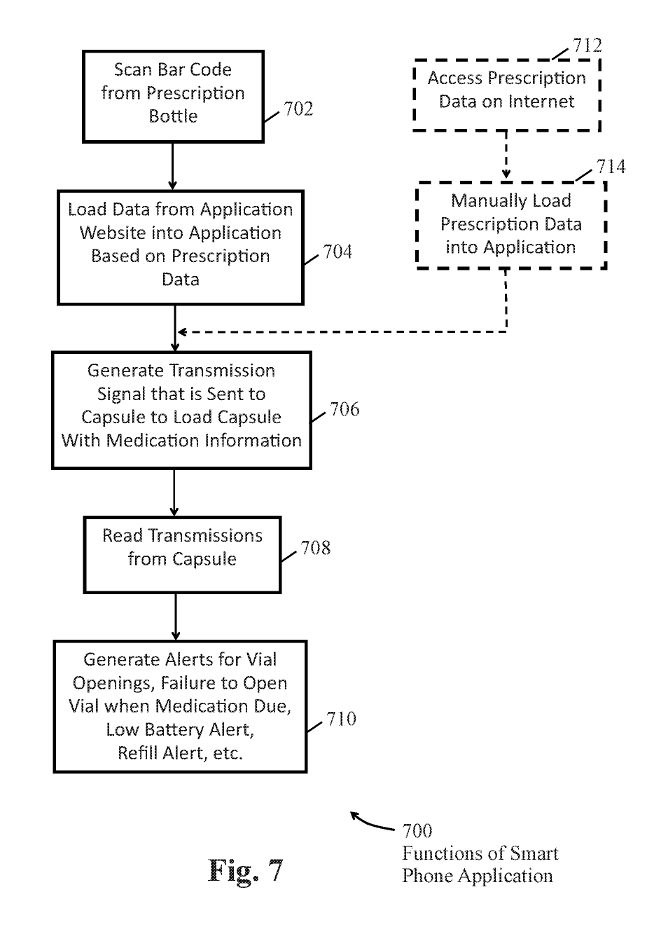

FIG. 6 is a flow diagram illustrating the process 600 of the compute engine, such as, for example only, a microprocessor 202 receiving dispensing data from an application that is run on a smart phone or server connected to a network. At step 602, the compute engine, such as, for example only, a microprocessor 202 receives the dispensing data. At step 604, the compute engine stores the count in the storage device 214 that is indicative of the time for the vial opening. At step 606, the counter 208 is started. At step 608, the process returns to step 404 of FIG. 4.

FIG. 7 is a schematic flow diagram of an embodiment of the functions of a smart phone application 700. The application may either reside on the smart phone or on a server attached to a network that is connected to the capsule 100. As illustrated in FIG. 7, a bar code on the prescription bottle can be scanned and transmitted to a server or a smart phone. Data is loaded from a prescription medicine website into the application based upon the prescription data at step 704. Alternatively, the user can access the prescription data on the Internet at step 712 and manually load the prescription data into the application at step 714. The process then proceeds to step 706, where a transmission signal is generated that is sent to the capsule to load the capsule with the medication information. For example, the medication information may include the times during which the medication should be taken by the user. At step 708, the application then reads transmissions from the capsule. At step 710, the application may generate alerts for the vial, or container opening, a failure to open the vial or container when the medication is due, low battery alerts, refill alerts, pilfering alerts, theft alerts, and other alerts.

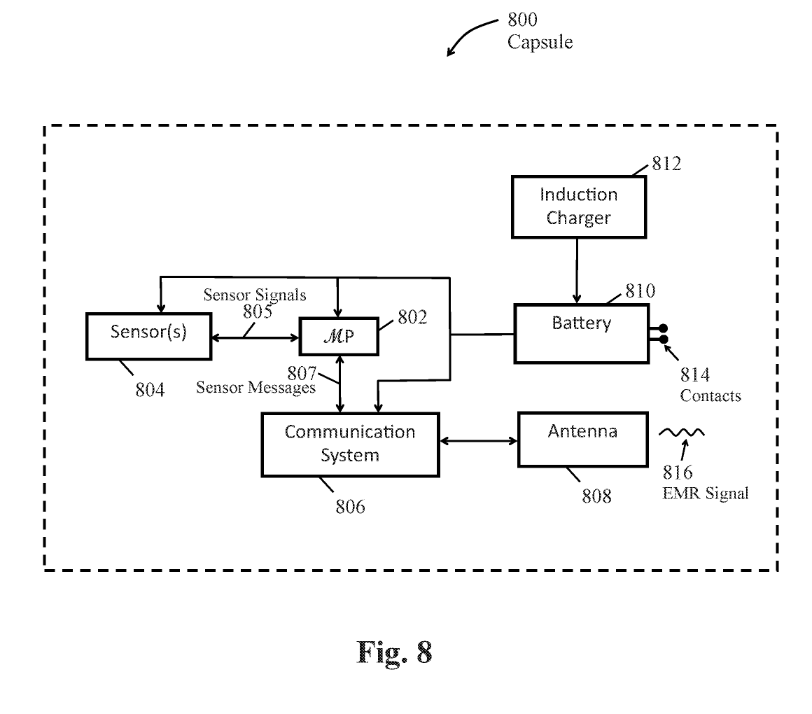

FIG. 8 is a schematic block diagram of another embodiment of the contents of a capsule 800. The contents of the capsule 800 are significantly reduced over that which is shown in capsule 100 of FIG. 2. As illustrated in FIG. 8, a compute engine, such as, for example only, a microprocessor 802 is connected to sensors 804 and receives the sensor signals 805 from the sensors 804. Compute engine, such as, for example only, a microprocessor 802 then generates sensor messages 807 that are transmitted to the communication system 806. The communication system 806 then generates an electromagnetic radiation (EMR) transmission signal that is transmitted by antenna 808. An electromagnetic radiation signal 816 is transmitted to either a local network, such as a WiFi network, or directly to a computer system, such as a smart phone. Antenna 808 also receives a signal, such as an EMR signal 816, which are transmitted to the communication system 806 and then to the compute engine, such as, for example only, a microprocessor 802. While embodiments of the invention disclosed herein utilize an EMR signal, as used herein and in the claims, the term “EMR signal” could comprise a signal including any of the following: Bluetooth signal, RF signal, or a substantial equivalent as recognized by one skilled in the art. These received signals may direct various actions that are controlled by compute engine, such as, for example only, a microprocessor 802, such as turning sensors on and off, directing the compute engine, such as, for example only, a microprocessor 802 to change the sensor messages 807 based upon input from the sensors 804, causing the compute engine, such as, for example only, a microprocessor 802 and sensors 804 to go into sleep mode, or other instructions for the compute engine, such as, for example only, a microprocessor 802, sensors 804 and communication system 806. The operation of the compute engine, such as, for example only, a microprocessor 802 is disclosed more fully in Figure I1. Battery 810 is connected to the sensors 804, compute engine, such as, for example only, a microprocessor 802 and communication system 806 to provide power for operation. An induction charger 812 can be used to charge the battery 810. Alternatively, contacts 814 can be used to charge the battery 810.

FIG. 9 illustrates an embodiment of a network communication system 900, such as a WiFi network, that can be utilized by the capsule 100. As shown in FIG. 9, the capsule 100 establishes a WiFi wireless connection 904. The wireless WiFi connection 904 may be the same as the EMR signal 816 of FIG. 8. The wireless WiFi connection 904 is established between the capsule TOO and a WiFi antenna 902. The WiFi antenna is connected to the Internet 906, or other network. The Internet 906, or other network, is then coupled to another WiFi antenna 908, which establishes a WiFi wireless connection 910 with a computer system 912, such as a smart phone, tablet, or other computer system. Computer system 912 can also communicate back to the capsule 100 through the WiFi communication system illustrated in FIG. 9.

FIG. 10 is a schematic diagram of a direct local communication link 1000 that is established between the capsule 100 and a smart phone 1004, or other computer device. The local communication link 1002 can be a Bluetooth link, or similar type of communication link, that can be established between the capsule 100 and the smart phone 1004. The local communication link 1002 may have a limited range of 50-100 feet, so that alerts generated by the capsule 100 may not be received by the smart phone 1004 until the smart phone is within range of a local communication link 1002. Of course, the capsule 100 can communicate both on the local communication link 1002, as illustrated in FIG. 10, or on a network, such as the WiFi communication system illustrated in FIG. 9.

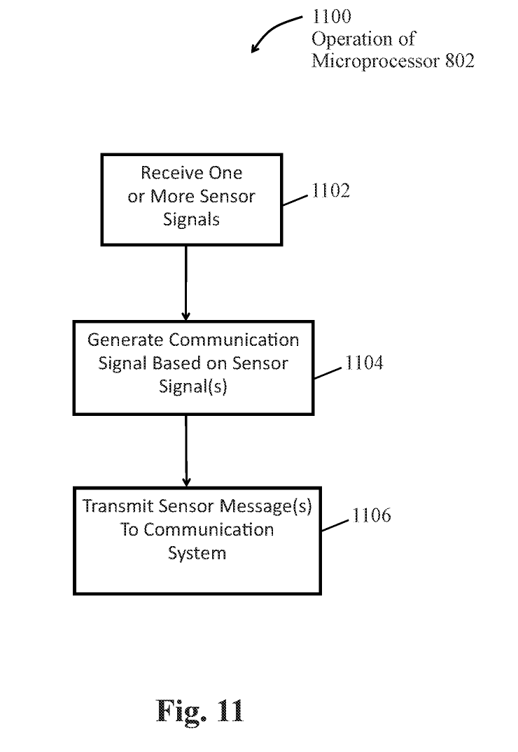

FIG. 11 is a schematic block diagram illustrating an embodiment of one set of operations of the compute engine, such as, for example only, a microprocessor 802 of FIG. 8. Of course, other operations of the compute engine, such as, for example only, a microprocessor 802 can be performed, such as, but not without limitation, the operations discussed above. As illustrated in FIG. 11, the compute engine, such as, for example only, a microprocessor 802 receives one or more of the sensor signals, such as sensor signals 805, as illustrated in FIG. 8. At step 1104, the compute engine, such as, for example only, a microprocessor 802 generates a communication signal that is designated as a sensor message 807 in FIG. 8. The sensor message 807 is based upon the sensor signals received by the compute engine, such as, for example only, a microprocessor 802. The compute engine, such as, for example only, a microprocessor 802, for example, may analyze the sensor signals and generate a sensor message 807, indicating that there has been an opening event. Alternatively, one or more sensor signals 805 may be simply transmitted as sensor messages 807 that indicate that a particular sensor has been activated. Further, the intensity of the sensor signal may also be indicated in the sensor message 807. In that manner, the sensor messages 807 can be analyzed by the computer or smart phone device to determine if a particular event has occurred, such as an opening event, a movement event, etc. At step 1106, the compute engine, such as, for example only, a microprocessor 802 transmits the sensor messages 807 to the communication system 806.

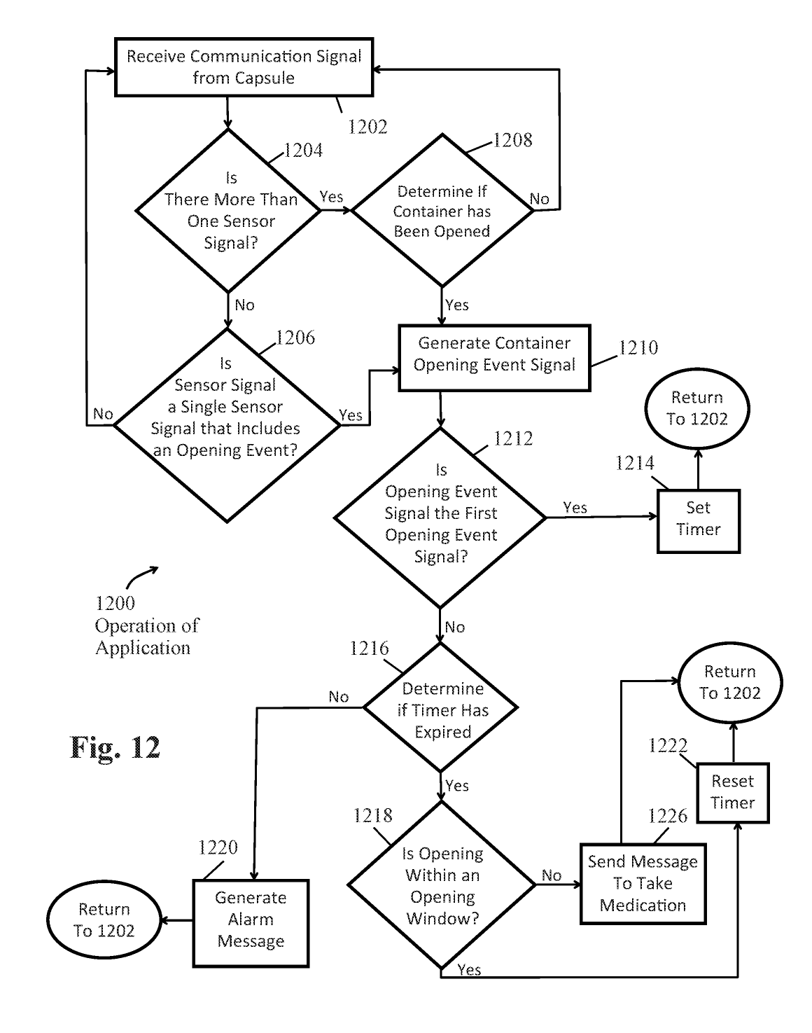

FIG. 12 is a schematic flow diagram of the operation of an application 1200 that may be used with the capsule 800, illustrated in FIG. 8. The application may reside on a smart phone 1004, or other computer device 912, which will be collectively referred to herein as a smart phone. At step 1202, the smart phone receives a communication signal from the capsule. That communication signal may be the EMR signal 816 from antenna 808, as shown in FIG. 8. The sensor message 807 that is sent to the smart phone contains information regarding the sensor signals 805. At step 1204, it is determined whether more than one sensor has generated an output. If so, the process proceeds to step 1208 to determine if the container has been opened. Again, a logic table may be used to determine if certain sensor signals indicate whether or not the container has been opened. The application 1200 may access stored logic tables, or other information, to make this decision. If there is not more than one signal, the process proceeds to decision step 1206. At decision step 1206, it is determined if the sensor signal is a single sensor signal that indicates an opening event. In other words, certain sensor signals clearly indicate that an opening event has occurred. In that regard, there may be only one sensor signal that is created by the sensors and activation of that sensor signal may indicate an opening event. In addition, other events may be sensed, and an opening event is merely exemplary of other events that may be sensed by the sensors. For example, a movement event may be detected. One or more sensors may indicate a movement event. A movement event may specifically refer to a movement event of a locked container. The occurrence of a movement event may indicate a theft of the container. Similarly, a detection of more than one event may indicate other situations, such as pilfering, theft, destruction of a container, or other situations of which a user may wish to be alerted. If the event has not occurred, the process proceeds back to step 1202. If the event has occurred, such as an opening event, the process proceeds to step 1210, wherein the application generates a container opening event signal. Of course, in the case of the detection of a movement event, the application generates a movement event signal.

Referring again to FIG. 12, the process then proceeds to step 1212 to determine if the opening event signal is the first opening event signal. In the example of a medicine vial, if the opening event is the first opening event signal, the process proceeds to step 1214, where a timer is set by the application to start a countdown for the next time the medicine vial should be opened so that the user can take his or her medication. The timer is then set at step 1214 and the process returns to step 1202. If it is determined that this is not the first opening event signal, the process proceeds to step 1216, where it is determined if the previously set timer has expired. If it has not expired, the process proceeds to step 1220, where an alarm message is generated, indicating an unauthorized opening of the bottle. The process then returns to step 1202. If it is determined that the timer has expired at step 1216, it is then determined at step 1218 if the opening is within an opening window. In other words, if the vial contains medication, and the user must take the medication periodically, there is a time period during which the user can take the medication, which is an opening window. If the container has been opened during the opening window, the process proceeds to step 1222 to reset the timer and the process returns to step 1202. If the vial has been opened outside of the opening window, a message signal is generated at step 1226 to inform the user to take the medication.

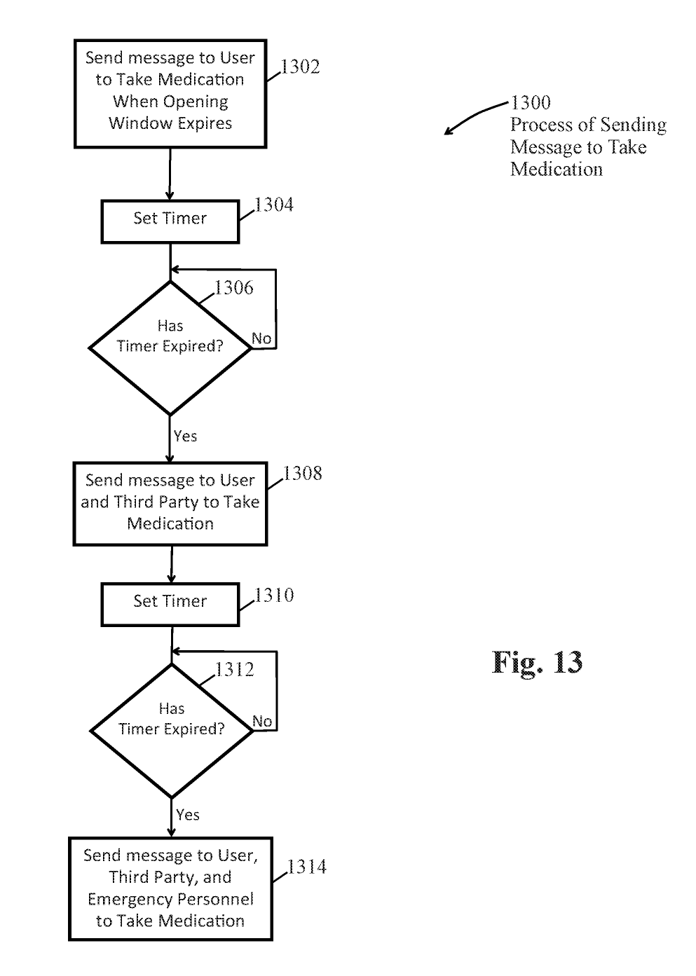

FIG. 13 is a schematic flow diagram of the process of sending messages to take medication, as illustrated at step 1226 of FIG. 12. At step 1302, a message is sent to the user to take medication when the opening window expires. As described above, the opening window is a time period during which a user can open the container and take medication without generating any type of message signal. When that time period expires, a message is generated by an application that runs on the user computer, such as a smart phone, indicating that medication should be taken. In association with purposes herein, in an embodiment of the invention, the term “application” may alternatively refer to applications running on a user computer or on other computers uncontrolled by a specific subject user, for instance applications that are automated, pre-programmed, algorithmic in nature or running at the direction of artificial intelligence. At step 1304, a timer is then set for a predetermined period. This predetermined period may be a reasonable period during which another reminder can be generated. At step 1306, it is determined whether the timer has expired, which was set at step 1304. If it has not expired, the process returns to step 1306. If it has expired, the process proceeds to step 1308. At step 1308, a message is sent to the user and some third party indicating that the medication should be taken. For example, a third party may be a relative of the user, or a caregiver. In embodiments of the invention, the term “caregiver” may specifically refer to a physician, nurse, other medical professional, family member or social worker, who assists in the identification, prevention, healthcare operations or treatment of a situation where care is needed, which may involve an illness or disability. The process then proceeds to step 1310, and another timer is set. Again, the timer is set at step 1310 for a reasonable period to generate a third reminder signal. At step 1312, it is determined if the timer that was set at step 1310 has expired. If it has not expired, the process returns to step 1312. If the timer has expired, the process proceeds to step 1314. At step 1314, a message is generated and sent to the user, the third party, and health care personnel for the user to take the medication. At that point, health care personnel may then respond to the message and make sure that the user takes the medication. Third parties may include insurance carriers and emergency personnel.

The embodiments of the present invention therefore provide for a capsule 100 that can take any desired shape that can provide alerts when medication is due, refill alerts, theft alerts, and other desired alerts. The capsule 100 is self-contained and can be placed in any desired container, including safes, locked storage devices, unlocked storage devices, or other devices, to protect prescription and non-prescription drugs, recreational drugs, valuables, such as jewelry, money, ammunition, guns, liquor, and any other items that a user would desire to protect. The device can also include a GPS device that indicates the location of the device. Various types of communication systems can be used to communicate with networks and/or a smart phone application. Automatic prescription refills can be transmitted by the capsule 100 based upon prescription information. A purchase order can be sent to a vendor also.

The foregoing description of the invention has been presented for purposes of illustration and description. It is not intended to be exhaustive or to limit the invention to the precise form disclosed, and other modifications and variations may be possible in light of the above teachings. The embodiments described herein were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

One of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The descriptive labels associated with the numerical references in the figures are intended to merely illustrate embodiments of the invention, and are in no way intended to limit the invention to the scope of the descriptive labels.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The terms “coupled” and “linked” as used herein is defined as connected, although not necessarily directly and not necessarily mechanically. A device or structure that is “configured” in a certain way is configured in at least that way, but may also be configured in ways that are not listed. Also, the sequence of steps in a flow diagram or elements in the claims, even when preceded by a letter does not imply or require that sequence.

What is claimed is:

1. A system generating message signals regarding events of a smart container comprising:
a cap placable on said container;
a capsule disposed in said container, said capsule comprising:
at least one sensor that generates at least a first sensor signal upon the occurrence of an event;
a compute engine that generates a message signal, based on said first sensor signal, indicating that said event has occurred;
a communication system that generates a transmission signal based on said message signal indicating said event has occurred;
an antenna that receives said transmission signal and transmits an EMR signal to a network that indicates said event has occurred;
a user computer or application that receives said EMR signal and generates second message signal.

2. The system of claim 1 wherein said second message indicates that there has been an opening event of said cap on said container.

3. The system of claim 1 wherein said second message is a message indicating movement of said container.

4. The system of claim 1 wherein said second message comprises a reminder to take medication.

5. The system of claim 4 wherein said second message comprises a series of escalating messages that are sent to recipients comprising a subset of at least caregivers or insurance providers.

6. The system of claim 1, said at least one sensor comprising a conductive sensor.

7. The system of claim 1, said at least one sensor comprising a pressure sensor.

8. The system of claim 1, said at least one sensor comprising a light sensor.

9. The system of claim 1, said at least one sensor comprising an accelerometer.

10. The system of claim 1, said at least one sensor comprising a capacitive sensor.

11. The system of claim 1, said at least one sensor comprising a humidity sensor.

12. The system of claim 1, said at least one sensor comprising a temperature sensor.

13. The system of claim 1, said at least one sensor comprising a thermocouple.

14. The system of claim 1, said at least one sensor comprising a water vapor sensor.

15. The system of claim 1, said at least one sensor comprising a desiccant.

16. The system of claim 1, further comprising a GPS system for indicating the location of said capsule.

17. The system of claim 1, further comprising a battery that has an induction charging system.

18. The system of claim 1, further comprising a battery that has contacts for charging said battery.

19. A method of generating messages indicating the status of a container comprising:
placing a capsule in said container, said capsule comprising a compute engine and at least one sensor;
detecting sensor signals from said at least one sensor with said compute engine that may indicate an occurrence of at least one event relating to said container;
generating a first message signal, with said compute engine, from signals transmitted by said at least one sensor;
transmitting said first message signal to at least one user computer or application;
receiving said first message at said at least one user computer or application and generating a second message signal based upon said first message signal.

20. The method of claim 19 wherein said second message signal indicates an opening of said container.

21. The method of claim 19 wherein said second message signal indicates a movement of said container.

22. The method of claim 21 further comprising:
activating a GPS transmitter upon said movement.

23. The method of claim 19 wherein said first message indicates a movement event of said container.

24. The method of claim 23 further comprising
determining whether said movement event occurred during an opening window; transmitting said second message of said movement event to said user computer or application;
determining if said movement event occurred outside of an opening window.

25. A system for protecting and controlling access to contents of a container comprising:
a locking cap placable on said container to lock said container to prevent access to said contents of said container;
a capsule, said capsule comprising:
at least one sensor that generates a first sensor signal when said locking cap is removed from said container;
a clock that generates a clock signal;
a counter that accumulates said clock signal and generates an accumulated clock signal;
storage that stores a predetermined count signal representative of an elapsed time period;
a compute engine that compares said accumulated clock signal with said predetermined count signal and generates a first message signal when said accumulated clock signal matches said predetermined count signal indicating said elapsed time has expired, and generates a second message signal whenever said first sensor signal is received prior to expiration of said elapsed time.

26. The system of claim 25, said first message indicating an instruction to take medication.

27. The system of claim 25, said first message indicating a movement event.

28. The system of claim 25, said second message indicating an opening event of said locking cap on said container.

29. The system of claim 25, said at least one sensor comprising a conductive sensor.

30. The system of claim 25, said at least one sensor comprising a pressure sensor.

31. The system of claim 25, said at least one sensor comprising a light sensor.

32. The system of claim 25, said at least one sensor comprising an accelerometer.

33. The system of claim 25, said at least one sensor comprising a capacitive sensor.

34. The system of claim 25, said at least one sensor comprising a humidity sensor.

35. The system of claim 25, said at least one sensor comprising a temperature sensor.

36. The system of claim 25, said at least one sensor comprising a thermocouple.

37. The system of claim 25, said at least one sensor comprising a water vapor sensor.

38. The system of claim 25, said at least one sensor comprising a desiccant.

39. The system of claim 25, further comprising a GPS system for indicating the location of said capsule.

40. The system of claim 25, further comprising a battery that has contacts for charging said battery.

41. The system of claim 25, further comprising a battery that has an induction charging system.

42. A method for protecting and controlling access to contents of a container comprising:
placing a capsule in said container, said capsule having a compute engine;
detecting sensor signals from said sensors with said compute engine indicating an opening event;
determining, with said compute engine, if said sensor signals indicate an opening event;
determining whether said opening event occurred during an opening window;
transmitting a message of said opening event to a user computer or application if said opening event occurred outside of an opening window.

43. The method of claim 42, further comprising:
determining whether said opening event indicates an unauthorized opening of said locked container.

44. The method of claim 42 further comprising:
detecting signals from said sensors that indicate a movement event;
determining whether said movement event occurred during an opening window;
transmitting a message of said event to a user application if said movement event occurred outside of an opening window indicating unauthorized movement of said locked container.

45. The method of claim 44 further comprising:
activating a GPS transmitter if said movement event is an unauthorized movement event.

46. A self-contained electronic device for insertion in a container that detects opening events of said container comprising:
at least one sensor that detects said opening events and generates opening event signals;
a compute engine that receives said opening event signals and generates opening event messages;
a battery that supplies power to said self-contained electronic device;
an antenna that transmits said opening event messages.
